(19) United States
(12) Patent Application Publication
(10) Pub. No.: US 2018/0048713 A1
(43) Pub. Date: Feb. 15, 2018

(54) MODULAR DATA ACQUISITION AND CONTROL SYSTEM

(71) Applicant: Sciemetric Instruments Inc., Kanata (CA)

(72) Inventor: Richard Michel Brine, Ottawa (CA)

(21) Appl. No.: 15/232,257

(22) Filed: Aug. 9, 2016

(51) Int. Cl. H04L 29/08; G05B 19/05; G06F 1/26; H04L 12/24

(52) U.S. Cl. CPC H04L 67/12; H04L 67/1097; H04L 41/0806; G05B 19/05; G06F 1/26; G05B 2219/15097

(57) ABSTRACT

A data acquisition and control system includes a controller. The controller includes a CPU and memory, a network switch, a synchronization switch and a power distribution network. The network switch is configurable by the CPU and couples the CPU with an external network, a plurality of directly connected data acquisition modules, and a plurality of networked data acquisition modules. The synchronization switch is configurable by the CPU couples the CPU with the plurality of directly connected data acquisition modules. The power distribution network supplies power to the plurality of directly connected data acquisition modules, and the plurality of networked data acquisition modules. The data acquisition modules comprise a CPU coupled to a local storage with the local storage storing an application program. The data acquisition modules also have a network interface, a programmable logic block, and a sensor interface comprising an excitation output and a data acquisition input.

### FIELD OF THE INVENTION

The present disclosure relates to manufacturing systems to monitor factory processes for control, data acquisition and analytics.

### BACKGROUND OF THE INVENTION

There is a push to continuously improve factory processes in order to reduce defects, detect defects as early in manufacturing processes as possible, and to determine the cause of defects. There exist numerous sensors to measure temperature, vibration, physical dimensions, rotational speed and position, voltage, current distance and a number of other parameters. There exists a number of actuators and controls to manage and run the manufacturing processes that must be adjusted and controlled precisely in time and value to obtain optimal results. Data is acquired using integrated hardware and software to enable monitoring and detection of faults and defective units and is then combined with data analytics to empower the implementation of constant improvement programs. Catching defects early in the process permits the reduction of financial and schedule impacts.

Specific examples of data acquisition and control systems include equipment used for leak detection, spindle monitoring, weld monitoring, dispensing of materials, monitoring of NVH (noise, vibration and harshness), press-fit monitoring and engine or motor testing.

This technology is not restricted to just manufacturing or factories. These systems can be used in many other applications such as research in universities, heating and air conditioning system monitoring on commercial buildings, stress and strain monitoring and data acquisition for aerospace design, civil engineering monitoring bridge fatigue, seismic monitoring, dynamometer control for motor testing, and many others. It is also relevant to Internet of Things (IoT) and Industrial Internet of Things (IIoT) technology and applications.

There are a number of drawbacks with existing solutions. One major drawback is that some existing systems use unintelligent data acquisition modules remotely or in racks with inflexible backplanes or controllers. This makes it difficult to apply stimulus at the right time and to sample data at the correct time. It also makes it difficult to synchronize the operations of multiple modules.

Other systems use intelligent platforms that allow custom high performance collection and control. However, commissioning the system or modifying the system, adding modules for example, involves complex programming, compilation, and configuration. Adding or deleting functionality from a system is a non-trivial task due to the time to reprogram it and the specialized skills required. This increases the investment required for an initial implementation and increases development times.

### BRIEF SUMMARY

A first embodiment of the invention includes a controller for a data acquisition and control. The controller comprises a CPU coupled to a memory. A network switch has a plurality of network input ports and a plurality of network output ports. The network switch is configurable by the CPU to connect any of the plurality of network input ports to any of the plurality of network output ports. The network switch couples the CPU with an external network, a plurality of directly connected data acquisition modules, and a plurality of networked data acquisition modules. The controller also includes a synchronization switch having a plurality of synchronization input ports and a plurality of synchronization output ports. The synchronization switch is configurable by the CPU to connect any of the plurality of synchronization input ports to any of the plurality of synchronization output ports. The difference in transmission delays through the synchronization switch between any of the plurality of synchronization input ports and any of the plurality of synchronization output ports is less than the difference in transmission delays through the network switch between any of the plurality of network input ports and any of the plurality of network output ports. The synchronization switch couples the CPU with the plurality of directly connected data acquisition modules. The controller also includes a power distribution network for supplying power to the plurality of directly connected data acquisition modules, and the plurality of networked data acquisition modules.

The controller may further comprise external ports interfacing to user interface devices.

The controller may further comprise an expansion port interfacing the network switch, the synchronization switch, and the power distribution network to the plurality of directly connected data acquisition modules. The controller sends configuration data stored in the memory to the plurality of directly connected data acquisition modules.

The network switch and the power distribution network may be coupled to the plurality of networked data acquisition modules. The controller sends configuration data stored in the memory to the plurality of networked data acquisition modules.

In another embodiment of the invention a data acquisition module comprises a CPU coupled to a local storage where the local storage stores an application program. The module also includes a network interface coupled to the CPU and to an integrated interface. The integrated interface receives power, network communications signals, and synchronization signals through the integrated interface. The module also includes a programmable logic block coupled to the CPU and configurable by the CPU using a configuration file received from the network interface and stored in the local storage. The module includes a sensor coupled to the programmable logic block through a data acquisition input. The data acquisition input receives data from an external transducer or sensor in response to the synchronization signals.

In some embodiments, the CPU configures the programmable logic block using a configuration file received from the network interface and stored in the local storage.

The data acquisition input includes an excitation output coupled to the programmable logic block that provides a variable signal to an external sensor, and a data acquisition input coupled to the programmable logic block receiving data from the external sensor.

In some embodiments the variable signal comprises a power supply that may be varied in time and magnitude. In other embodiments, the data acquisition input performs data conditioning and analog to digital conversion on the received data from the external sensor.

In further embodiments of the invention the programmable logic block includes a transmit FIFO that receives a digital power level from the CPU and transmits the digital power level to the excitation output. The excitation output converts the digital power level into an analog power level.

In another embodiment the CPU stores in the local storage a plurality of samples of the conditioned and digitized data received from the external sensor and performs data analysis on the plurality of samples to produce a pass/fail result. The CPU may receive database data from the network communication signals of the network interface and utilize the database data to produce the pass/fail result. The database data may be based on historical data related to the operation of the external sensor.

In other embodiments, the programmable logic block is also coupled to the network interface and receives the synchronization signals from the network interface and provides trigger signals to the excitation output and the data acquisition input.

In some embodiments, the configuration file also includes calibration information and further comprises information to reconfigure the programmable logic block and the data acquisition input from an initial configuration.

In some embodiments, the pass/fail result is produced prior to the completion of the data acquisition sequence.

In other embodiments, the CPU executes a detection program to vary the excitation output and receive data to identify the external transducer and the second external transducer. The data is used to retrieve a configuration file associated with the external transducer and the second external transducer that is used to configure the module.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is an overall block diagram of a complete data acquisition and control system.

FIG. 2 is a block diagram of one example of a modular data acquisition and control slice.

FIG. 3 is a block diagram of a switch for distribution of power, data, and synchronization signals.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

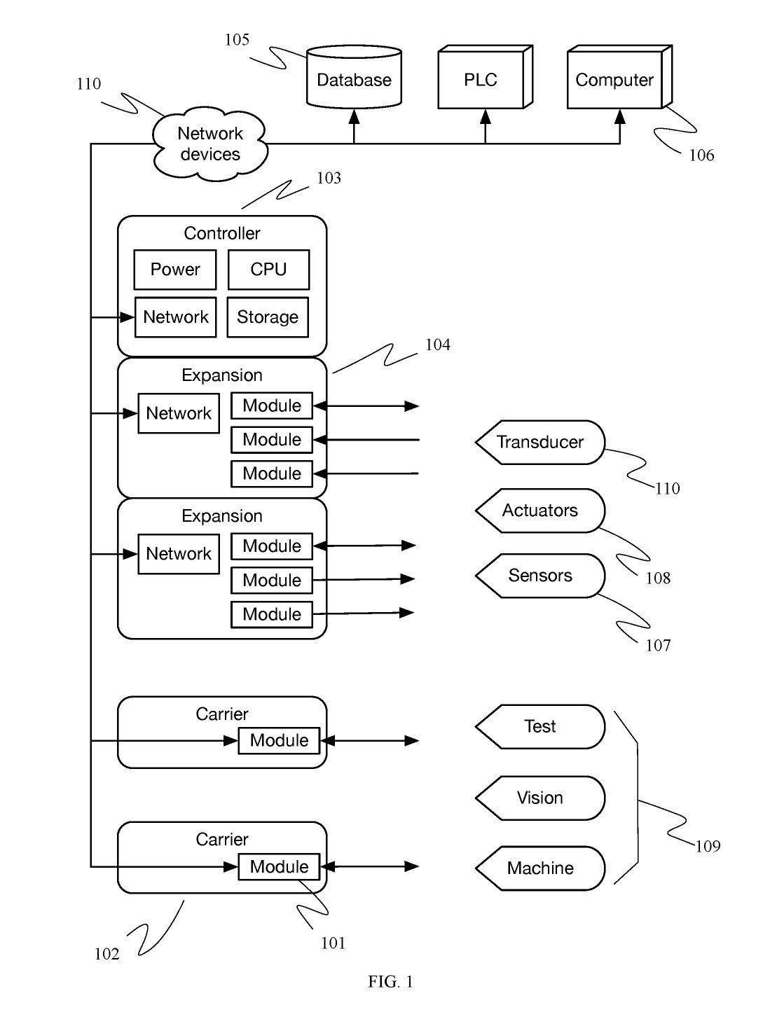

FIG. 1 shows one embodiment of the invention illustrating the major components of the system. These components include modules 101, carriers 102, controllers 103, expansion units 104, databases 105, and computers 106. Modules are self contained data acquisition and control units that interface to external sensors 107, actuators 108, and other factory equipment 109. Each module has a dedicated processor allowing fully independent operation or collective operation with other modules on the network 110 or in a multi-module combined system. Modules 101 are highly configurable and come in a variety of common types. Physically, modules have similar dimensions and shapes which allow them to be mounted in carriers 102 in close proximity to factory equipment 109. Controllers provide hardware and software to deliver power, networking, and synchronization to modules, and act as a central hub for a multi-module combined system. Expansion units 104 attach directly to the controller and allow for dense mounting of modules and low latency access to the network and synchronization buses. Databases 105 may be located in memory in modules, controllers, or remotely on the network. Computers 106 may be used to configure, program, and monitor the overall system.

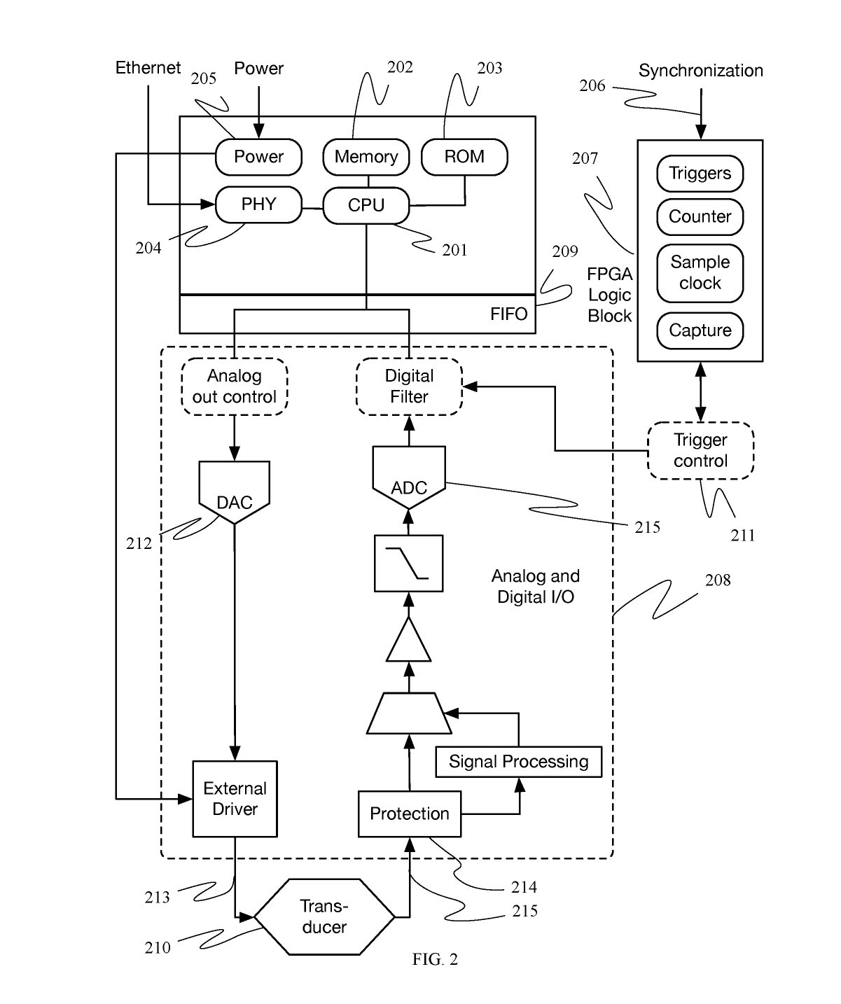

This data acquisition and control system is build around what are referred to as modules. One embodiment of a module is shown in FIG. 2. The system is build around these flexible, configurable, modular, data acquisition and control modules that may be thought of as slices. Modules can be thought of as slices because they include all the circuitry to stimulate and read data from sensors and actuators, process the data, make intelligent decisions on the data and communicate with other systems including a backend system and database. Since a module is self contained a single module can be used on its own in a simple system.

Modules have their own processor 201, RAM memory 202, and non-volatile ROM memory 203 for code storage. Non-volatile memory can be SSD such as mSATA form factor, flash memory, hard disk, semiconductor ROM or any suitable medium. A networking physical layer circuit (PHY) 204 and power circuitry 205 are also included. The module runs an operating system which may be a real-time operating system (RTOS). Modules are available in a number of general or specific types which each type being configurable and programmable to perform a variety of data acquisition and control tasks. Modules are capable of data processing, data analysis, and data compression on board and may run high level application software. Application software can take many forms including providing dashboards, data summaries customized for individual users. The module 101 has access to data from remote databases 105 in a controller or on the network, local databases in the module, and PLCs (programmable logic controllers). Modules are capable of working together with other modules to carry out complex tasks. Self-diagnostic and self-calibration routines may be run by the modules, and the status may be logged or relayed to a monitoring system or operator. Modules may also execute programs to discover the type of transducer, which may be a sensor, actuator, or both. The module can be configured so that an excitation output is provided to the actuator or other identification input of transducer and an identification response read by the module input. Alternatively, the sensor input may read an identification response from the transducer, which may be in a test or configuration mode. This identification response or signature will identify the transducer and can be used by the module to load a configuration file specific to that transducer or class of transducer. The configuration file can be read from local memory, non-volatile memory (ROM) or may be obtained over the network from a controller, a database, or other configuration system. The configuration file may contain historical calibration information, taking into account external considerations such as temperature, age, number of units tested, and others. The configuration file may also include pass/fail criteria for a test that may be based on final readings after a period of time, a number of samples spaced in time, continuous readings in time, and other criteria.

Physically, modules are similar and have a common interface to back-end systems for power, networking, and synchronization. Modules may be constructed out of metals, such as aluminum, or plastic and may include gaskets at their external interfaces to be hermetically sealed to be compliant with standards such as IP Code. Modules may be hot swappable, be auto discovered by the system when attached or detached, and be automatically configured by the system. Each module 201 implements a common interface for power 205, networking 204, and synchronization interfaces 206. Networking 204 may be Ethernet but any wired or wireless network may be used that works in the factory environment where the system will be used. Modules may also implement support for IEEE 1588 (Precision Time Protocol) hardware to synchronize the excitation of sensors and data acquisition.

A configurable logic block 207 is included to interface to analog and digital I/O 208; actuators, sensors, and transducers. It may be implemented in an FPGA, controller, or similar programmable logic. The FPGA can be configured to support different functions when reset or when power is cycled. This may include support for FIFOs 209 for reading and writing to external sensors and actuators 210.

A dedicated synchronization interface 206 is included in modules to enable high precision triggering 211 by modules and between modules. Dedicated synchronization logic is combined with the configurable logic block 207 to implement complex triggers, counters, sample clocks, and capture logic.

Modules may 101 include analog and digital front ends 208 to interface to equipment 109, transducers 110, sensors 107 and actuators 108. In some embodiments the analog and digital front ends may be galvanically isolated from the rest of the module. Based on its programming, the module's CPU 201 writes data to a FIFO 209 which drives a digital-to-analog converter (DAC) 212 which is used to control a programmable analog signal 213 that may also supply power to sensors 108. This can be used to put sensors into specific modes to detect, test or configure them. The programmable analog output can be varied in amplitude, polarity and time, supply a PWM (pulse-width modulation) signal, and supply varying amounts of current. When acquiring data or reading from a sensor the signal is first put through a protection circuit 214. After that, the signal may optionally be processed in the analog domain and amplified. An analog-to-digital converter (ADC) 215 digitizes the signal which may be digitally filtered before being placed in to a FIFO 209 for further processing by the module CPU 201.

Modules are highly configurable and one module can provide multiple functions through its programmable CPU 201 and FPGA configurable logic 207. Multiple types of modules may be supplied to support functions of a particular type. Examples of module types that can be used by the system include analog I/O, digital I/O, encoders, power outputs, H-bridges for motor control, communications (RS-422), and combinations of the above.

A key feature of the system is that modules 101 can be placed in close proximity to factory equipment 109 and provide stimulus and excitation to transducers 110, sensors 107, and actuators 108 including varying digital and analog outputs and power to put sensors into test modes, configuration, or acquisition modes. Modules can provide excitation to actuators as well as reading the sensor outputs to qualify and characterize processes.

A variety of remote module carriers 102 are provided to the system including single, dual, and quad carriers. The carriers securely and compactly hold a number of standard sized modules. Carriers that hold any number of modules may be used and network, power, and synchronization inputs may be shared between modules using the same carrier.

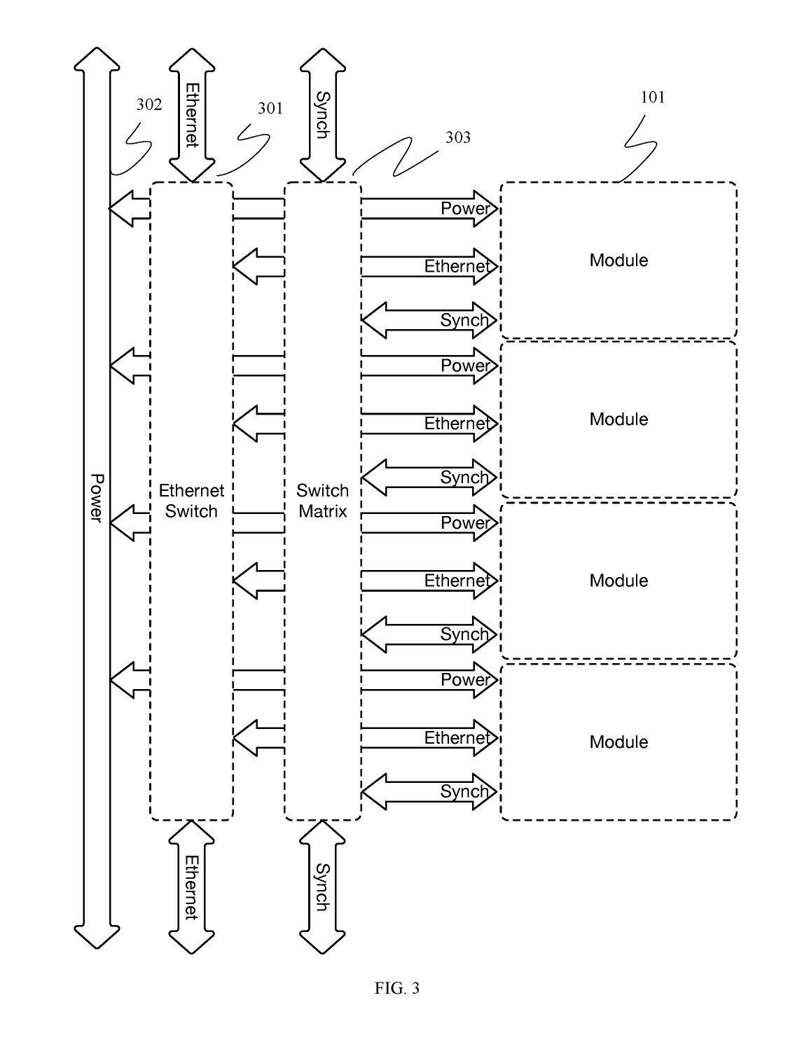

Controllers 103 provide a number of features as shown in FIG. 3. These include providing a network switch 301, power distribution 302, providing a synchronization network 303, providing tightly coupled expansion capability, and providing shared external interfaces. The network 301 is used for non-time sensitive synchronization (>10 ms between modules), time stamping of data, global time synchronization, and data transfer. In some embodiments of the invention Ethernet is used. In other embodiments Power-over-Ethernet is used to provide networking as well as power using the same twisted pair physical interface. Within the system a proprietary physical layer may be used for Ethernet, power, and the synchronization network. The controller 103 contains a network switch 301 with provide deterministic latencies and delays to all ports. The switch itself may have a variety of architectures and may have cross-bar, shared bus, switched or any other suitable architecture used. When connecting externally to back end servers, databases, general purpose computers, or the Internet, standard networking protocols may be used. Other physical media can be used such as wireless and fiber optics as dictated by the environment where the system is being used. The number of ports on the switch determines the number of modules in the group that can be synchronized for high precision operations.

Ethernet and most networking protocols are limited in their precision due to the overhead of the protocol stacks. For high precision synchronization the synchronization network 303 allows for the transmission of synchronization pulses and signals (data) to single modules 101, arbitrary groups of modules or to all modules. The synchronization switch matrix 303 is ideally implemented in a programmable cross-bar switch with a known, minimum difference in delays and latencies between any combination of ports. The switch may support point-to-point and point-to-multipoint or broadcast transmission. The switch may characterize and compensate for the delay or latency between any two ports in order to control or minimize the skew between synchronization signals received by modules. The synchronization network interfaces to multiple modules to support high precision measurements controls for tasks such as engine encoder angles, complex triggering involving multiple modules, PID control, and SAE J2716 SENT (Single Edge Nibble Transmission) protocol communications.

Controllers 103 may also support a number of shared system resources that support user interfaces and removable memory. User interface options include video interfaces such as HDMI, DVI, and VGA as well as USB ports to interface to keyboards, computer mice, track pads and other user input devices. USB ports may also be used to load configuration files, firmware updates, and to perform other maintenance and monitoring tasks of the system.

Expansion units 104 are coupled to controller units 103 and are directly connected to the network bus 301, synchronization bus 303, and power distribution 302. Expansion units 104 hold a number of modules 101 and multiple expansion units can be connected to a controller 103. Modules housed in expansion units benefit by being directly connected to the network 301 and synchronization 303 buses which provide deterministic delays and latencies and support extremely accurate timing for triggering and synchronization signals. Some embodiments of the invention support, for example, ten expansion modules that may be connected to a controller 103. In this case, each expansion module 104 may house four modules 101 for a total of 40 modules. Controllers 103 and expansion units 104 are designed to be connected together rigidly to resist vibrations and may include gaskets at their external interfaces to be hermetically sealed to be compliant with standards such as IP Code.

One feature of embodiments of the invention is the process of configuration for the controller 103 and modules 101. The system has access to historical data which may be used to configure and test modules. For sensors, historical data includes test stimulus applied to the sensor, the results received, information on the test environment at the time, and the results of the operation. This historical data can be used to develop, test, and simulate software for the modules. Module software contains programs to configure and operate the embedded module CPU 201 and the module's programmable logic block 207. When developing module software, the designer has access to an extensive library of advanced test functions including NVH (noise vibration, and harshness) testing, leak testing, welding, press-fit, dispensing and machine monitoring. The libraries and routines support standard processes, transformations, and data analysis. Libraries also include functions to access RTCs (real-time clocks) and program signal generators, ramps, triggers and the sequencing of applying stimulus and acquiring data with a single module or multiple modules working together. User libraries can be created and customized. Modules can be programmed with pass/fail criteria as well so that all processing of data may be done with only the final pass/fail results returned to an optional monitoring system. The pass/fail result may be issued at the end of the excitation and data acquisition sequence. Data can be collected at the end of the process or at defined points during the process. However, in order to speed up the manufacturing process, modules can continuously track the data acquired from a sensor or transducer over time and verify it against an expected results curve. If the acquired data deviates from the results curve it may issue a fail result before the end of data acquisition sequence. In other cases, a pass may be issued before the end of the data acquisition sequence if the results up to that time meet or are within certain pre-defined or dynamically determined criteria. Data may be kept stored on the module 101, saved in a local database on the module, transmitted to a networked or cloud database 105 in real-time, or only at fixed, predetermined times, or when specific events occur.

When a module 101 is inserted or installed into the system it starts communicating and is automatically detected by the system. The system then accesses the correct software module including programming for the module's CPU 201 and programmable logic 207 and downloads it to the module over the network connection 204. The module is then reset, if necessary, and can start operating. Alternatively, a module can simply wake up and run using the configuration last loaded. If a module is removed from the network, this may also be automatically detected and the system is then aware that the module is not present.

The modules are highly programmable as both the embedded CPU 201, the programmable logic 207, and selected other features may be programmed. Though the modules 101 come in several generic types, for the most part they are universal with their software, firmware, and programmable logic defining their function. An example is a module 101 with a single programmable power output 213 and a single analog input 215. Since modules are universal and highly programmable it can be initially configured and later reconfigured to support a large number of sensors, actuators, transducers, and applications. The power output 213 can be programmed to supply a variable power output varying both the voltage and current of the output that can be used to enable test, configuration, and operation modes of a transducer 110 or actuator 108. The analog input 215 is able to receive the sensor output, limit and amplify the signal, convert it to a digital signal where various signal processing routines can be run on it. Later the same module may be connected to another sensor and quickly reprovisioned by the system detecting that the module is now connected to a different sensor and by loading new software onto the module that may be downloaded through the network 110 or read from local storage.

Modules 101 are a self-contained data acquisition and analysis device. Once they have acquired data they are able to calculate analytics on that data. Modules support scripts, and have adjustable parameters and limits that allow for the customization of their software without compiling the modified software. This feature makes possible closed loop test design including data capture, data storage, analysis, access to libraries, download to modules.

Controlling, configuring and monitoring the overall system can be done through user interfaces connected to a controller but is more likely to be done through a remote computer connected over the network. This remote computer may contain or have access to a central database and has the ability to do high-level, real-time reporting. A user interface may include dashboards, analytics, and provide the ability to setup and configure the system and its applications over the network. Displays can be rugged displays, desktop computers, laptops, tablets, cell phones, or similar devices and be connected to a controller or over the network. Security can be use to safeguard data with encryption on the module, encrypted communications, and in local and global databases and in cloud storage.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A controller for data acquisition and control, the controller comprising:
a CPU, the CPU coupled to a memory;
a network switch, the network switch having a plurality of network input ports and a plurality of network output ports, the network switch being configurable by the CPU to connect any of the plurality of network input ports to any of the plurality of network output ports, the network switch coupling the CPU with an external network, a plurality of directly connected data acquisition modules, and a plurality of networked data acquisition modules;
a synchronization switch, the synchronization switch having a plurality of synchronization input ports and a plurality of synchronization output ports, the synchronization switch being configurable by the CPU to connect any of the plurality of synchronization input ports to any of the plurality of synchronization output ports, the difference in transmission delays through the synchronization switch between any of the plurality of synchronization input ports and any of the plurality of synchronization output ports being less than the difference in transmission delays through the network switch between any of the plurality of network input ports and any of the plurality of network output ports, the synchronization switch coupling the CPU with the plurality of directly connected data acquisition modules; and
a power distribution network for supplying power to the plurality of directly connected data acquisition modules, and the plurality of networked data acquisition modules.

2. The controller of claim 1 further comprising external ports, the external ports interfacing to user interface devices.

3. The controller of claim 1 further comprising an expansion port, the expansion port interfacing the network switch, the synchronization switch, and the power distribution network to the plurality of directly connected data acquisition modules, the controller sending configuration data stored in the memory to the plurality of directly connected data acquisition modules.

4. The controller of claim 1 wherein the network switch and the power distribution network are coupled to the plurality of networked data acquisition modules, the controller sending configuration data stored in the memory to the plurality of networked data acquisition modules.

5. A data acquisition module, the module comprising:
a CPU, the CPU coupled to a local storage, the local storage storing an application program, the application causing the CPU to execute a data acquisition sequence;
a network interface, the network interface coupled to the CPU, the network interface coupled to an integrated interface, the integrated interface receiving power, network communications signals, and synchronization signals through the integrated interface;
a programmable logic block, the programmable logic block coupled to the CPU and configurable by the CPU;
a data acquisition input, the data acquisition input coupled to the programmable logic block, the data acquisition input receiving data from an external transducer in response to the synchronization signals.

6. The data acquisition module of claim 5 wherein the CPU configures the programmable logic block using a configuration file received from the network interface and stored in the local storage.

7. The data acquisition module of claim 5 further comprising an excitation output, the excitation output coupled to the programmable logic block, the excitation output providing a variable signal to a second external transducer.

8. The data acquisition module of claim 7 wherein the variable signal comprises a power supply, the variable signal varying in time and magnitude.

9. The data acquisition module of claim 5 wherein the data acquisition input performs data conditioning and analog to digital conversion on the received data from the external sensor.

10. The data acquisition module of claim 7 wherein the programmable logic block includes a transmit FIFO;
the transmit FIFO receiving a digital power level from the CPU and transmitting the digital power level to the excitation output, the excitation output converting the digital power level into an analog power level.

11. The data acquisition module of claim 9 wherein the CPU stores in the local storage a plurality of samples of the conditioned and digitized data received from the external sensor, the CPU performing data analysis on the plurality of samples to produce a pass/fail result.

12. The data acquisition module of claim 11 wherein the CPU receives database data from the network communication signals of the network interface, the CPU also utilizing the database data to produce the pass/fail result.

13. The data acquisition module of claim 12 wherein the database data is based on historical data related to the operation of the external sensor.

14. The data acquisition module of claim 7 wherein the programmable logic block is also coupled to the network interface, the programmable logic block receiving the synchronization signals from the network interface and providing trigger signals to the excitation output and the data acquisition input.

15. The data acquisition module of claim 6 wherein the configuration file comprises information to reconfigure the programmable logic block and the data acquisition input from an initial configuration, the configuration file also comprising calibration information.

16. The data acquisition module of claim 11 wherein the pass/fail result is produced prior to the completion of the data acquisition sequence.

17. The data acquisition module of claim 7 wherein the CPU executes a detection program to vary the excitation output and receiving data to identify the external transducer and the second external transducer, the data used to retrieve a configuration file associated with the external transducer and the second external transducer.
